(19) United States
(12) Patent Application Publication
(10) Pub. No.: US 2005/0070155 A1
(43) Pub. Date: Mar. 31, 2005

(54) Jumper cable system, jumper cable system kit, and battery charging system

(76) Inventor: Randy J. Horenstein, Miami, FL (US)

Correspondence Address: LITMAN LAW OFFICES, LTD., P.O. BOX 15035 CRYSTAL CITY STATION, ARLINGTON, VA, 22215, US

(21) Appl. No.: 10/991,464

(22) Filed: Nov. 19, 2004

Related U.S. Application Data
(63) Continuation-in-part of application No. 10/345,983, filed on Jan. 17, 2003, now abandoned.

(51) Int. Cl. H01R 13/52

(52) U.S. Cl. 439/522

(57) ABSTRACT

A vehicle jumper cable system, kit and charging kit, for permanent installation on a new vehicle, retrofitting an older vehicle, and charging a deenergized vehicle battery, including at least a detachable section for connecting the deenergized vehicle battery with an auxiliary battery source to “jump-start” or “boost” the deenergized battery. The system and kits include at least cable sections connected together by hermaphroditic connectors for ensuring proper polarity, and safe connections. Additional extension cables are provided which include the hermaphroditic connectors on each end. Also, a fusible component is provided in at least one conductor of the various cable sections for additional safety in preventing damage, injury and death. The battery charger has a hermaphroditic connector for connecting to the deenergzed battery via one of the cable sections.

### CROSS-REFERENCE TO RELATED APPLICATION

This application is a continuation-in-part of U.S. Utility patent application Ser. No. 10/345,983, filed Jan. 17, 2003, the entire disclosure of which is incorporated by reference.

### BACKGROUND OF THE INVENTION

1. Field of the Invention

The present invention relates to jumper cable system for vehicles. More specifically, the jumper cable system is modular and has a safety feature. In addition, the jumper cable system is provided in a kit form. Finally, the system includes a battery charging component.

2. Description of the Invention

Vehicle “jumper” cables are well known for “jump starting” or “boosting” undercharged vehicle batteries, such as cars, motorcycles, boats, etc. “Jump-starting” involves transferring electrical energy from a charged battery to an undercharged or discharged battery so that the electrical starter can be operated to turn over an engine. The jump start may be supplied from (1) a second vehicle with a fully charged battery; (2) an A.C. battery charger which may be switchable between a trickle charge mode and a high amperage starting mode; and (3) a battery booster having a rechargeable battery which may be used for jump starting a vehicle or as a D.C. power supply for twelve volt accessories. Once the engine on the vehicle having the undercharged or discharged battery is started, the vehicle can then begin generating its own power using its generator or alternator and the cables are then removed.

Motorcycles, all-terrain vehicles, snowmobiles, jet-skis, as well as a host of other larger type vehicles such as automobiles, semi-tractors, farm tractors, trucks, cargo and passenger vans, are equipped with batteries that are generally inaccessible to jumper cables. That is, substantial effort must be expended to remove obstructing structures (such as a seat) to reach the battery terminals in order to connect jumper cables to the battery terminals. In addition, it is commonly understood that the standard lead-acid batteries widely used in automotive vehicles produce highly volatile vapors, which can ignite upon the presence of a spark. When deenergized batteries are coupled to an energizing battery source (such as another vehicle), an electrical spark is generated, possibly causing an explosion, which may lead to damage, injury, or death.

Several attempts have been made in the prior art to attain easy access to the non-easily accessible battery of modern automotive vehicles, however, no other device appears to codify the aspects of safely and unmistakingly connect a deenergized battery to a charging source.

None of the above inventions and patents, taken either singly or in combination, is seen to describe the instant invention as claimed. Thus a jumper cable system, jumper cable system kit, and battery charging system solving the aforementioned safety problems is desired.

### SUMMARY OF THE INVENTION

The invention is directed to vehicle jumper cables, and to a battery charger having a connector, which is attachable to the jumper cables. In particular, the inventive cable includes a hermaphroditic connector that ensures proper polarity when the cable is connected either to another vehicle or other vehicle battery, or to the battery charger.

Moreover, the inventive cable can be provided in a kit form to include a first cable section connected permanently at one end to the terminals of a vehicle battery and having a hermaphroditic connector at its opposite end, a second cable section equipped with a hermaphroditic connector at one end and clamps at its opposite end for connecting to the terminal posts of a standard post-type battery, and a third cable section equipped with hermaphroditic connectors at both ends for connecting the first and second cable sections, e.g., as for boosting a vehicle battery from a car battery or for boosting one vehicle from another vehicle equipped with the same cable section. Thus the j ump-starting any currently marketed vehicle has become a labor-intensive activity.

The present invention reduces or removes the labor-intensive aspect of jump-starting vehicles by providing a readily connectable modular jump starting cable, one part of which is permanently installed on the vehicle and having at least one other part that connects the vehicle in distress to the power-supplying vehicle, e.g., to a battery of another passenger vehicle similarly equipped with a permanently installed cable part, or to a non-similarly equipped vehicle with the appropriate connector, or battery charging device. Furthermore, the inventive cable is provided with hermaphroditic connectors that ensure proper polarity when connected.

Additionally, the risk of damage, injury, or death reduction due to the highly volatile environment of conventionally automotive vehicular battery jump-starts is accomplished by providing the remote cable connections using the hermaphroditic connector so that when the cables are connected, any arcing is produced internally of the connectors, away from the generally vicinity of the batteries where the explosive vapors may be present. Also, a safety factor encompassed in the present embodiments is a fusing link to prevent over current from causing damage to either the deenergized battery of the energizing battery source. The fusing link is provided in at least one cable conductor, and causes an open circuit if the electrical parameters exceed a predetermined operational limit.

The aspects of the present invention will become readily apparent upon further review of the following specification and drawings.

### BRIEF DESCRIPTION OF THE DRAWINGS

FIG. 1A is a fragmented, environmental, perspective view showing a vehicle mounted jumper cable system according to the present embodiment.

FIG. 1B is an environmental, perspective view showing a vehicle with a deenergized battery receiving a jump start from another energizing battery source according to the present embodiment.

FIG. 1C is an environmental, perspective view showing a vehicle with a deenergized battery receiving a jump start from another energizing battery source according to the present embodiment.

FIG. 2A is a perspective view of the jumper cable system kit according to an embodiment of the present invention.

FIG. 2B is an environmental view of the jumper cable system kit according to an embodiment of the present invention.

FIG. 3 is a perspective view of the battery charger including the hermaphroditic connection.

Similar reference characters denote corresponding features consistently throughout the attached drawings.

### DETAILED DESCRIPTION OF THE PREFERRED EMBODIMENTS

The present invention is directed to a multi-part jumper cable for boosting the battery of a vehicle or for charging a vehicle battery using hermaphroditic connectors. The jumper cable system and battery charging system of the present invention are used by a myriad of vehicles, including motorcycles, all-terrain vehicles, snowmobiles, jet-skis, as well as a host of other larger type vehicles such as automobiles, semi-tractors, farm tractors, trucks, cargo and passenger vans, all of which utilize an electric battery source for starting an internal combustion engine.

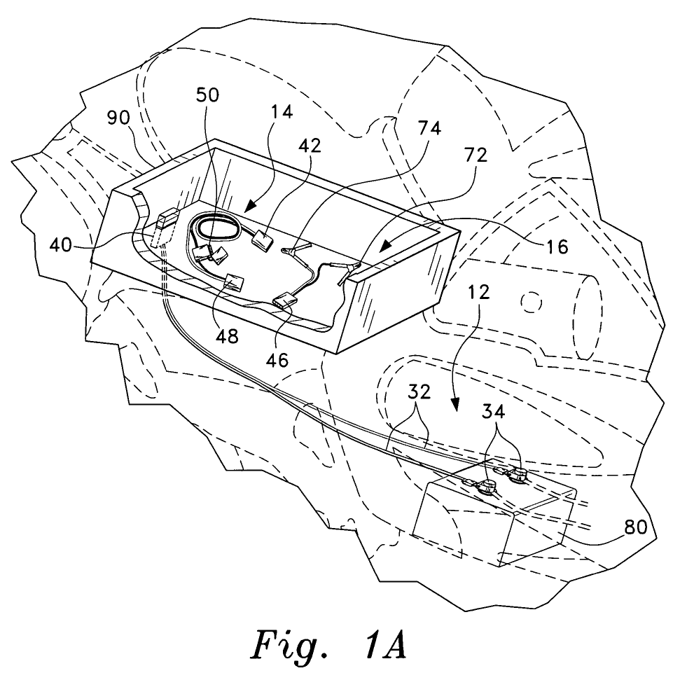

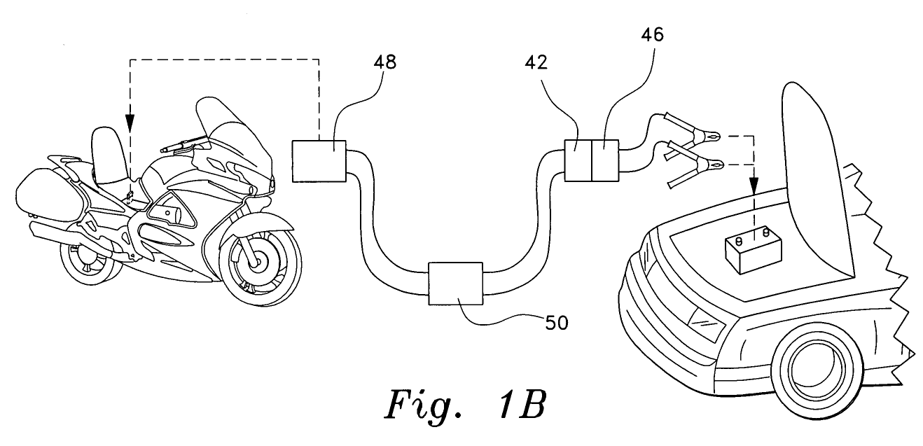

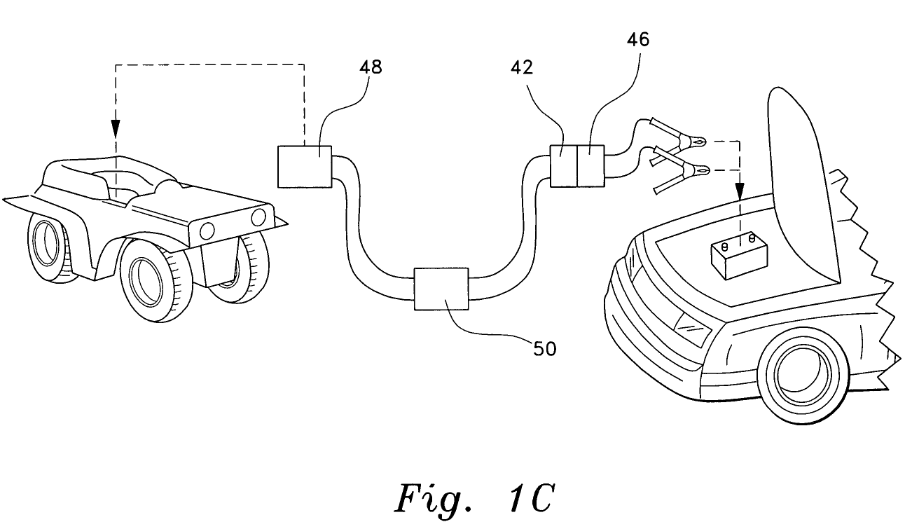

FIGS. 1A, 1B, and 1C illustrate the disposition and operational uses of the embodiment of the invention. Specifically, FIG. 1A shows a cutaway view of a vehicle 10 showing a vehicle battery 80, a first portion 12 of the multi-part jumper cable connected at one end to the battery terminals 34, and a housing 90 containing a second portion 14 and a third portion 16 of the jumper cable. FIGS. 1B and 1C show the versatility of the jumper cable system, by interchangeably jump starting various vehicles, equipped with the permanently installed cable portion, or not equipped with the permanently installed cable portion. FIGS. 1B and 1C show the vehicle 10 having a deenergized battery being connected to an energized battery source, from at least another vehicle, with the modular cable connection therebetween. By utilizing the hermaphroditic connectors on the various cable portions, the polarity of the cable conductors is maintain between the batteries. Thus ensuring the jump-start of the deenergized battery as a quick and ‘foolproof’ with reduced risk to damage, injury, and death.

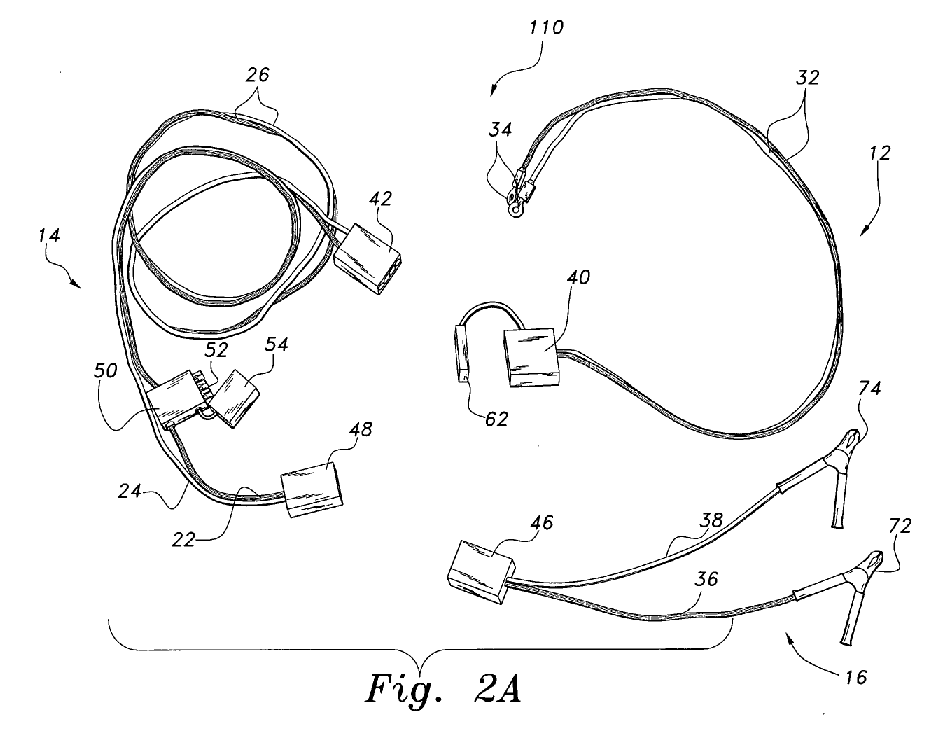

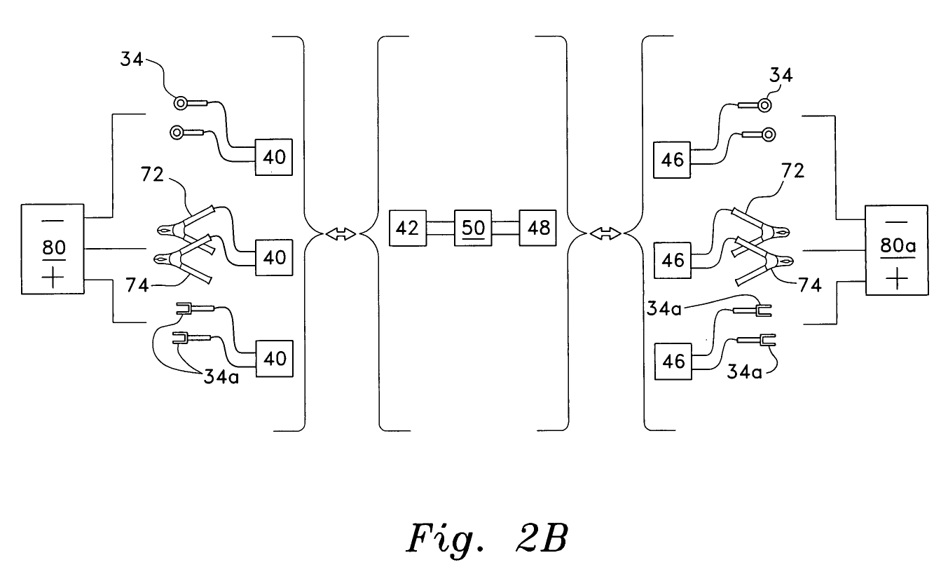

FIG. 2A shows a detailed view of a kit including all three sections that make up the multi-part jumper cable, i.e., sections 12, 14, and 16.

The permanently installed cable section 12 includes two electrical cables 32 color-coded to distinguish between the positive cable (typically red in color) and the negative cable (typically black in color), so that a person using the cable will maintain proper polarity during use, i.e., when “jumping” or “boosting” the deenergized battery. However, it is well known in the art that the specific color coding is solely arbitrary, so long as the two colors are individually distinguishable from each other.

The housing 90 defines a storage compartment for the second and third portions, 14 and 16. Depending upon the type of vehicle, the storage compartment may be located under the seat as shown. Alternatively, the storage compartment may be elsewhere, such as to the rear or either side of the seat. In other words, the storage compartment

The second portion 14 of the multi-part jumper cable has first and second ends including hermaphroditic connectors, 42 and 48, respectively, and a fuse 50 intermediate the two ends on one of the two cables, generally the positive cable 22, the rating of the fuse should be on the order of 30 amperes. It, is noted that the fuse is disclosed in the second section 14, however, it is well within the purview of the scope of the embodiments of the invention, that the fuse may be in any one or more of the segments. In this manner, the overall safety features would be a self-backup variation on the use of a defective fuse having an improper rating.

The third portion 16 of the jumper cable is provided at one end with a hermaphroditic connection 46. The opposite end of the third portion 16 of the jumper cable has positive and negative cables, 36 and 38, respectively, and terminates in alligator type clamps 72 and 74 which are adapted for attachment to the terminal posts of a post-type charging battery, such as the type commonly used on passenger vehicles.

As seen in FIG. 2B, the kit may include a myriad of connectors for the first section 12 and third section 16. Typically, the ends may have alligator clips 72, 74, additional end type connectors may be selected from the types of eyelets 34 or forked connectors 34a, or any other type of end connectors available in the automotive industry for making temporary or permanent battery connections.

When the battery 80 is undercharged and requires a “jump” or a “boost” from another battery, such as from a car battery, the vehicle is placed in relative proximity to the car (or other vehicle). Jumper cable section 16 is removed from the storage compartment 90 and clamps 72 and 74 are attached to the respective positive and negative terminal posts of the post-type charging battery. Then cable section 14 is removed from the storage compartment and one end (i.e., either connector 42 or 48) is connected to connector 40 of the first section and the opposite end (i.e., remaining connector 48 or 42) is connected to connector 46 of the second section, thereby completing the boosting circuit.

Hermaphroditic connectors 40 and 42 may be any known type of hermaphroditic connector in which the connectors are identical, and which can only be connected in a manner in which the polarity is ensured, i.e., in which the positive terminal of the fully charged battery is directly connected with the positive terminal of the undercharged battery and the shape of the positive terminal on each connector is identical. Preferably the hermaphroditic connector is of a type exemplified by the connector taught in U.S. Pat. No. 4,963,102, previously incorporated herein. It is noted that although the reference teaches a three-conductor cable, the same connector is used herein for connecting a two-connector cable, i.e., a cable having a positive and a negative cable corresponding to the positive and negative poles of a vehicle battery.

On the positive cable wire 22 a fuse 52 is provided. The fuse is contained in its own housing 50 with a protective cap 54. The fuse is preferably a thirty ampere (30A) blade fuse that corresponds with the wire gauge size capable of “jumping” batteries, e.g., ten gauge AWG.

Thus, the second section 14 may be used either to connect a first jumper cable section 12 fixed to the battery of the vehicle receiving the jump start to a another first jumper cable section 12 attached to the charging battery on a second vehicle, or as an extension cable between the first jumper cable section 12 and third jumper cable section 16 to extend the length of the jumper cable when charging from a passenger car or other vehicle. A general length of the cable portions 12 and 16 should be approximately 3 feet, while cable portion 14 has general length of approximately 6 feet.

When two vehicles are equipped with a 3-piece kit as shown in FIGS. 1B and 1C, one of the vehicles can then be used to “jump-start” the second by simply connecting the installed cable section 12 of the two vehicles together with the second section 14.

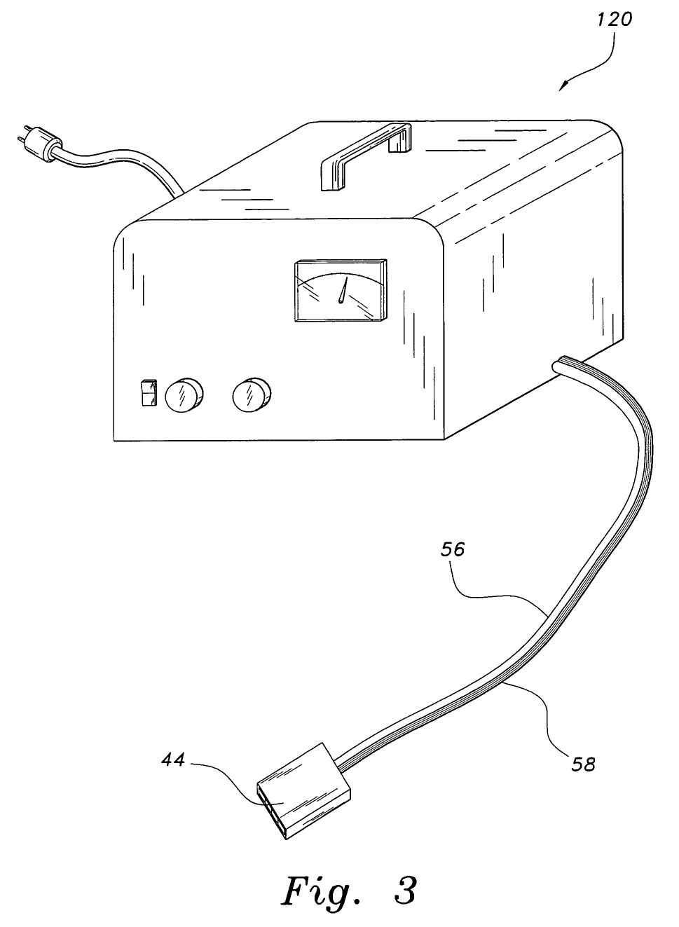

FIG. 3 shows an optional battery charger 120 including a hermaphroditic connector 44 that ensures proper polarity in the wires 56 and 58 during use. The battery charger 120 shown in FIG. 3 is switchable between a trickle charge mode for deep charging of the battery, and a starting mode for providing a current boost to the dead battery during starting of the vehicle. The hermaphroditic connector 44 may be attached directly to connector 40 of the first jumper cable section 12, or indirectly through connector 42 or 48 of extension cable 14. Battery charger 120 may be included with the kit 110 (FIG. 2). Alternatively, a rechargeable battery booster equipped with cables, 56 and 58, and hermaphroditic connector 44 may be substituted for battery charger 120.

The jumper cable kit may be provided with as little as two parts, for example, the kit may be included as a accessory item for a model vehicle having a permanently connected first section manufactured in the vehicle, as seen in FIG. 1. The accessory item kit would therefore include the second section cable portion and the third section cable portion having only a single connection adapter (e.g., alligator clamps). The jumper cable kit may include a myriad of components, making the versatility of the kit useable for virtually every battery powered electric starter internal combustion engine. In addition, a total kit may further include a battery charging device (see FIG. 3), including the three jumper cable portions, first section 12, second section 14 and third section 16. Both the first and third sections 12 and 16 may each include plural segments having the various end connections as alternatives.

It is to be understood that the present invention is not limited to the embodiments described above, but encompasses any and all embodiments within the scope of the following claims.

1. A jumper cable system for vehicles, said system comprising:
a first cable portion, said first cable portion including a first cable conductor and a second cable conductor, said first cable conductor having a first terminal connection end, and a second conductor end, said second cable conductor having a first terminal connection end, and a second conductor end;
wherein each said first terminal end being adapted to be attached to a first vehicular battery source;
a first hermaphroditic connector; said first hermaphroditic connector being attached to each said second connector end of said first cable portion;
a second cable portion, said second cable portion including a first cable conductor and a second cable conductor, said first cable conductor having a first terminal connection end, and a second conductor end, said second cable conductor having a first terminal connection end, and a second conductor end;
wherein each said first terminal end being adapted to be attached to a second vehicular battery source;
a second hermaphroditic connector; said second hermaphroditic connector being attached to each said second connector end of said second cable portion;
wherein said first hermaphroditic connector and said second hermaphroditic connector are identical, and said first hermaphroditic connector and said second hermaphroditic connector releasably mate with each other in order to electrically connect the first jumper cable section with the second jumper cable section while maintaining proper polarity between the two-wire cables.

2. The jumper cable system according to claim 1, further comprising an alligator clamp attached to each terminal end of said first and second cable portions;
wherein said terminal ends of said first cable portion are releasably connected to a deenergized battery by said alligator clamp at each terminal end, and said terminal ends of said second cable portion are releasably connected to an energizing source;
whereby said first and second hermaphroditic connectors are releasably engaged so as to electrically connect the deenergized battery with the energizing source without causing sparks in the vicinity of explosive gases.

3. The jumper cable system according to claim 1, further comprising:
a third cable portion including a first cable conductor and a second cable conductor, said first cable conductor having a first connection end, and a second connection end, said second cable conductor having a first connection end, and a second connection end;
a first hermaphroditic connector; said first hermaphroditic connector being attached to each said first connection end of said first cable conductor and said second cable conductor of said third cable portion; and
a second hermaphroditic connector; said second hermaphroditic connector being attached to each said second connection end of said first cable conductor and said second cable conductor of said third cable portion;
wherein said third cable portion is releasably connected between said first and second cable portions.

4. The jumper cable system according to claim 3, further comprising means for mounting said first hermaphroditic connector to the vehicle at a location remote from the vehicular battery source.

5. The jumper cable system according to claim 1, wherein each said first terminal end includes an eyelet for electrically connecting each respective said first terminal end of said first cable conductor to the first vehicular battery source.

6. The jumper cable system according to claim 1, wherein each said first terminal end includes a forked coupler for electrically connecting each respective said first terminal end of said first cable conductor to the first vehicular battery source.

7. The jumper cable system according to claim 6, further comprising a safety control device inserted in at least one cable conductor.

8. The jumper cable system according to claim 7, wherein said safety control device is a fuse.

9. The jumper cable system according to claim 7, wherein said safety control device is a fusible link.

10. The jumper cable system according to claim 7, wherein said safety control device includes means for interrupting the electrical connection between the deenergized battery and the energizing source.

11. A jumper cable kit for vehicles, said kit comprising:
a first cable portion, a second cable portion, and a third cable portion;
said first cable portion including a first cable conductor and a second cable conductor;
said first cable conductor having a first terminal connection end, and a second conductor end;
said second cable conductor having a first terminal connection end, and a second conductor end;
means for attaching each said first terminal end to a vehicular battery post; and
a first hermaphroditic connector; said first hermaphroditic connector being attached to each said second connector end of said first cable portion;
said second cable portion including a third cable conductor and a fourth cable conductor, and a safety control device inserted in at least one of said third cable conductor and said fourth cable conductor;
said third cable conductor having a first connection end, and a second connection end;
said fourth cable conductor having a first connection end, and a second connection end;
a second hermaphroditic connector; said second hermaphroditic connector being attached to each said first connection end of said third cable conductor and said fourth cable conductor of said second cable portion; and
a third hermaphroditic connector; said third hermaphroditic connector being attached to each said second connection end of said third cable conductor and said fourth cable conductor of said second cable portion; and
said third cable including a fifth cable conductor and a sixth cable conductor; said fifth cable conductor having a first terminal connection end, and a second conductor end;
said sixth cable conductor having a first terminal connection end, and a second conductor end;
wherein each said first terminal end being adapted to be attached to a second vehicular battery source; and
a fourth hermaphroditic connector; said fourth hermaphroditic connector being attached to each said second connector end of said third cable portion;
wherein said first hermaphroditic connector and said third hermaphroditic connector are identical, said second hermaphroditic connector and said fourth hermaphroditic connector are identical, said first hermaphroditic connector releasably mates with at least one of said second hermaphroditic connector and said fourth hermaphroditic connector, and said third hermaphroditic connector releasably mates with said fourth hermaphroditic connector;
whereby said hermaphroditic connectors electrically connect the cable sections in order

12. The jumper cable kit according to claim 11, wherein said means for attaching each said first terminal end includes an eyelet fixedly attached to a vehicular battery source post.

13. The jumper cable kit according to claim 11, wherein said means for attaching each said first terminal end includes a clamp releasibly attached to a vehicular battery source post.

14. The jumper cable kit according to claim 11, wherein said means for attaching each said first terminal end includes a forked coupler fixedly attached to a vehicular battery source post.

15. The jumper cable kit according to claim 11, wherein said means for attaching each said first terminal end includes an eyelet fixedly attached to a vehicular battery source post.

16. The jumper cable kit according to claim 11, further comprising a safety control device inserted in at least one cable conductor.

17. The jumper cable kit according to claim 11, further comprising a battery charging device including at least one hermaphroditic connector;
wherein said at least one hermaphroditic connector is identical said second and fourth hermaphroditic connectors, for coupling said battery charger to the deenergized vehicular battery source and maintaining the proper polarity.

18. A battery charging system kit, comprising:
a battery charging device having at least three modes of operation, and including an output cable having at least one hermaphroditic connector;
wherein said at least three modes of operation are off, charge, and boost;
a cable segment having a length and two ends, said cable segment including at least two conductor cable portions between said two ends, and a hermaphroditic connector supported at each one of said two ends;
a plurality of connector adaptors, each one of said plurality of connector adapters including a hermaphroditic connector, at least two conductor cable portions, and at least two connectors;
wherein said hermaphroditic connector of each one of said connector adaptors connects with one of said hermaphroditic connectors of cable segment and said battery charging device;
whereby when in use, said cable segment optionally provides an extension between said battery charging device and one of said plurality of connector adaptors.

19. The battery charging system kit according to claim 18, further comprising a safety control device disposed in at least one cable conductor.
